(19) United States
(12) Patent Application Publication
(10) Pub. No.: US 2007/0031049 A1
(43) Pub. Date: Feb. 8, 2007

(54) IMAGE COMPRESSION DEVICE AND IMAGE COMPRESSION METHOD

(75) Inventor: TAE EUNG KIM, GYEONGGI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/428,375

(22) Filed: Jun. 30, 2006

(30) Foreign Application Priority Data
Aug. 8, 2005 (KR) 10-2005-0072271

(51) Int. Cl. G06K 9/36

(52) U.S. Cl. 382/239

(57) ABSTRACT

The present invention relates to an image compression device. The image compression device includes a memory to which image signal data is input and in which the image signal data is stored; an image format section, having the memory built-in, that blocks the input image signal data into a plurality of blocks having a predetermined size to output; a discrete cosine transform section that performs the discrete cosine transform on each of the blocks input from the image format section so as to output discrete cosine transform coefficients; a rearranging section that rearranges and outputs the discrete cosine transform coefficients from low frequency components to high frequency components for each of the blocks input from the discrete cosine transform section; a bit data storing section that measures a ratio of the integrated value of edge components of a macro block to the integrated value of overall edge components of a frame by extracting edge components of predetermined signal data in the input video signal data, and stores bit data calculated from the ratio; a scaling factor generator that receives image quality mode data selected by a user and the bit data stored in the bit data storing section so as to assign an amount of bits to the macro block, and fixes a scaling factor therefrom; a quantizer that quantizes the discrete cosine transform coefficients for each block, input from the rearranging section, in accordance with the scaling factor fixed by the scaling factor generator; a coding bit estimating section that receives the discrete cosine transform coefficients quantized by the quantizer so as to estimate an amount of bits when the discrete cosine transform coefficients are coded; a buffer that stores the discrete cosine transform coefficients quantized by the quantizer; a coefficient selector that compares the respective absolute values of the discrete cosine transform coefficients stored in the buffer, and compares the amount of bits assigned by the scaling factor generator and the amount of bits estimated by the coding bit estimating section; a variable length coder that variable-length codes the discrete cosine transform coefficients, stored in the buffer, so as to output; and a bit counter that calculates a remaining amount of bits in the amount of bits assigned by the scaling factor generator after variable-length coding, and outputs the calculated amount of bits to the scaling factor generator.

### CROSS-REFERENCE TO RELATED APPLICATIONS

The application claims the benefit of Korea Patent Application No. 2005-0072271 filed with the Korea Industrial Property Office on Aug. 8, 2005, the disclosure of which is incorporated herein by reference.

### BACKGROUND OF THE INVENTION

1. Field of the Invention

The present invention relates to an image compression device and an image compression method, and more specifically, to an image compression device, in which an amount of data which is assigned to a predetermined region within a frame can be varied in accordance with image complexity by adding a bit data storing section, and an image is compressed by comparing an assigned amount of data and an estimated amount of data when discrete cosine transform coefficients are coded so that rate control is performed more accurately, and an image compression method.

2. Description of the Related Art

In general, an image apparatus for implementing a function of digital cameras mounted on digital cameras or mobile phones compresses image data, received through CCD (Chare Coupled Device) or CMOS (Complementary Metal Oxide Semiconductor) sensor, within a digital camera or mobile phone so as to store the data in a memory or to transmit the data to an external storing device.

When a user presses a release button of an image apparatus, such as a digital camera, mobile phone, smart phone, PDA or the like, so as to take a certain image, the image apparatus takes a momentary still image so as to compress the image through such a method as JPEG or JPEG2000 or so as not to compress. Then, the image apparatus stores the image in a memory. Further, while a user selects a recording mode, a digital camcorder for taking motion pictures compresses consecutively input motion pictures through such a method as MPEG so as to store in a memory.

The image compression in an image processor is performed by adjusting quantization parameters of a quantizer of an internal compression module. Generally, when a compression ratio is lowered in order to obtain a fine image, the quantization step size is decreased by adjusting the quantization parameters. When an amount of data is desired to be reduced by increasing a compression ratio even though a fine image is not obtained, the quantization step size is increased.

In such a method, however, both a simple image and a complex image have the same quantization step size as each other. Therefore, images are compressed without weight according to the image complexity, which makes it difficult to adjust an amount of data.

In other words, a memory capacity is wasted for a simple image which can be obtained through a low compression ratio, and data cannot be assigned any more for a complex image which needs a large amount of data. Therefore, it is difficult to adjust an amount of data.

Accordingly, in accordance with the image complexity within a screen, more data needs to be assigned to a complex image, and less data is desired to be assigned to a simple image.

FIG. 1 is a diagram showing an internal block diagram illustrating an image compression device according to the related art. As shown in FIG. 1, the image compression device includes a memory 101, an image format section 102, a discrete cosine transform section 103, a first quantizer 104, a second quantizer 105, a rate controller 106, and a variable-length coder 107.

First, image signal data composed of Y, Cb, Cr signals is input to the image format section 102. The image format section 102 blocks the image signal data into a plurality of blocks with 8×8 pixels so as to output to the discrete cosine transform section 103.

The discrete cosine transform section 103 performs the discrete cosine transform on each of the blocks, input from the image format section 102, so as to output discrete cosine transform coefficients corresponding to frequency components. Then, the discrete cosine transform section 103 arranges the discrete cosine transform coefficients through zigzag scan so as to store the arranged discrete cosine transform coefficients in the memory.

At this time, when an amount of target data per frame is desired to be fixed, the second quantizer 105 is additionally provided to divide a frame into small regions so that an amount of data is uniformly assigned to each of the regions.

The second quantizer 105 inputs the uniformly assigned amount of data to the rate controller 106, and the rate controller 106 finds an appropriate scaling factor after previously checking an amount of data which is encoded in accordance with an estimated scaling factor.

After that, the first quantizer 104 serves to quantize the discrete cosine transform coefficients for each block, input from the memory 101, in accordance with the scaling factor adjusted by the rate controller 106.

The variable length coder 107 serves to variable-length code the discrete cosine transform coefficients quantized by the first quantizer 104 so as to output compressed data.

In the above-described image compression device and image compression method according to the related art, a uniform amount of bits is assigned to the respective regions regardless of the image complexity. Therefore, a signal-to-noise (S/N) ratio is poor for the region having a complex image.

Further, several second quantizers should be provided in order to perform more accurate rate control.

### SUMMARY OF THE INVENTION

An advantage of the present invention is that it provides an image compression device, in which an amount of data which is assigned to a predetermined region within a frame can be varied in accordance with image complexity by adding a bit data storing section, and an image is compressed by comparing an assigned amount of data and an estimated amount of data when discrete cosine transform coefficients are coded so that rate control is performed more accurately, and an image compression method.

Additional aspects and advantages of the present general inventive concept will be set forth in part in the description which follows and, in part, will be obvious from the description, or may be learned by practice of the general inventive concept.

According to an aspect of the invention, an image compression device includes a memory to which image signal data is input and in which the image signal data is stored; an image format section, having the memory built-in, that blocks the input image signal data into a plurality of blocks having a predetermined size to output; a discrete cosine transform section that performs the discrete cosine transform on each of the blocks input from the image format section so as to output discrete cosine transform coefficients; a rearranging section that rearranges and outputs the discrete cosine transform coefficients from low frequency components to high frequency components for each of the blocks input from the discrete cosine transform section; a bit data storing section that measures a ratio of the integrated value of edge components of a macro block to the integrated value of overall edge components of a frame by extracting edge components of predetermined signal data in the input video signal data, and stores bit data calculated from the ratio; a scaling factor generator that receives image quality mode data selected by a user and the bit data stored in the bit data storing section so as to assign an amount of bits to the macro block, and fixes a scaling factor therefrom; a quantizer that quantizes the discrete cosine transform coefficients for each block, input from the rearranging section, in accordance with the scaling factor fixed by the scaling factor generator; a coding bit estimating section that receives the discrete cosine transform coefficients quantized by the quantizer so as to estimate an amount of bits when the discrete cosine transform coefficients are coded; a buffer that stores the discrete cosine transform coefficients quantized by the quantizer; a coefficient selector that compares the respective absolute values of the discrete cosine transform coefficients stored in the buffer, and compares the amount of bits assigned by the scaling factor generator and the amount of bits estimated by the coding bit estimating section; a variable length coder that variable-length codes the discrete cosine transform coefficients, stored in the buffer, so as to output; and a bit counter that calculates a remaining amount of bits in the amount of bits assigned by the scaling factor generator after variable-length coding, and outputs the calculated amount of bits to the scaling factor generator.

The memory is a frame memory in which the input image signal data is stored for each frame, and the image format section having the frame memory built-in distinguishes the input image signal data for each frame, and blocks the distinguished image signal data into a plurality of blocks having a predetermined size for each frame so as to output the blocked data.

The memory is a slice memory in which the input image signal data is stored for each slice with 16×N (N is an positive integer) rows, and the image format section having the slice memory built-in distinguishes the input image signal data for each slice, and blocks the distinguished image signal data into a plurality of blocks having a predetermined size for each slice so as to output the blocked data.

The image signal data is composed of Y, Cb, Cr signal data.

The Y, Cb, Cr signal data is formatted in the ratio of 4:2:2 so as to be stored.

The Y, Cb, Cr signal data is formatted in the ratio of 4:2:0 or 4:1:1 so as to be stored.

The plurality of blocks, having a predetermined size, of the image format section are four Y signal blocks, two Cb signal blocks, and two Cr signal blocks, each block having 8×8 pixels.

The plurality of blocks, having a predetermined size, of the image format section are four Y signal blocks, one Cb signal blocks, and one Cr signal blocks, each block having 8×8 pixels.

The predetermined signal data of the bit data storing section is Y signal data.

The macro block in the bit data storing section and the scaling factor generator is composed of four Y signal blocks with 8×8 pixels.

The coefficient selector converts the plurality of discrete cosine transform coefficients, of which the absolute values are small, into 0 when the amount of bits assigned by the scaling factor generator is smaller than the amount of bits estimated by the coding bit estimating section.

According to another aspect of the invention, an image compression method includes receiving and storing image signal data; blocking the input image signal data into a plurality of blocks with a predetermined size so as to output; performing the discrete cosine transform on each of the output blocks so as to output discrete cosine transform coefficients; rearranging the output discrete cosine transform coefficients from low frequency components to high frequency components for each block so as to output; measuring a ratio of the integrated value of edge components of a macro block to the integrated value of overall edge components of a frame by extracting edge components of predetermined signal data in the input image signal data, and storing bit data calculated from the ratio; receiving the stored bit data and image quality mode data selected by a user so as to assign an amount of bits to the macro block, and fixing a scaling factor therefrom; quantizing the output discrete cosine transform coefficients for each block in accordance with the fixed scaling factor; receiving the quantized discrete cosine transform coefficients, and estimating an amount of bits when the discrete cosine transform coefficients are coded; storing the quantized discrete cosine transform coefficients, comparing the respective absolute values of the stored discrete cosine transform coefficients, and comparing the assigned amount of bits and the estimated amount of bits; variable-length coding the stored discrete cosine transform coefficients to output; and calculating an amount of bits, remaining after variable-length coding, in the assigned amount of bits.

In the step of receiving and storing image signal data, the input image signal data is stored for each frame, and in the step of blocking the input video signal data to output, the input image signal data is distinguished for each frame, and is blocked into a plurality of blocks with a predetermined size for each frame so as to be output.

In the step of receiving and storing image signal data, the input image signal data is stored for each slice with 16×N (N is a positive integer) rows, and in the step of blocking the input image signal data to output, the input image signal data is distinguished for each slice, and is blocked into a plurality of blocks with a predetermined size for each slice so as to be output.

In the step of receiving and storing image signal data, image signal data composed of Y, Cb, Cr signal data is input.

In the step of receiving and storing image signal data, the Y, Cb, Cr signal data is formatted in the ratio of 4:2:2 so as to be stored.

In the step of receiving and storing image signal data, the Y, Cb, Cr signal data is formatted in the ratio of 4:2:0 or 4:1:1 so as to be stored.

In the step of blocking the input video signal data to output, four Y signal blocks, two Cb signal blocks, and two Cr signal blocks, each block having 8×8 pixels, are blocked and output.

In the step of blocking the input video signal data to output, four Y signal blocks, one Cb signal block, and one Cr signal block, each block having 8×8 pixels are blocked and output.

In the step of measuring a ratio and storing bit data calculated from the ratio, edge components of Y signal data are extracted.

The steps of storing bit data calculated from the ratio and receiving the stored bit data so as to assign an amount of bits are performed with the macro block being set to a basic unit, the macro block composed of four Y signal blocks with 8×8 pixels.

The step of storing the quantized discrete cosine transform coefficients further includes converting the plurality of discrete cosine transform coefficients, of which the absolute values are small, into 0 when the assigned amount of bits is smaller than the estimated amount of bits.

When a remaining amount of bits is calculated in the step of calculating a remaining amount of bits, the amount of bits is input as data of the step of receiving the stored bit data so as to assign an amount of bits.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an internal block diagram showing an image compression device according to the related art;

FIGS. 2A and 2B are internal block diagrams showing an image compression device according to the related art;

FIG. 3 is a graph showing a scaling factor according to an amount of bits of a macro block;

FIGS. 4A and 4B are diagrams showing an 8×8 block of discrete cosine transform coefficients;

FIG. 5 is a graph showing an amount of target bits in accordance with the number of blocks; and

FIGS. 6A and 6B are flow charts showing an image compression method according to the invention.

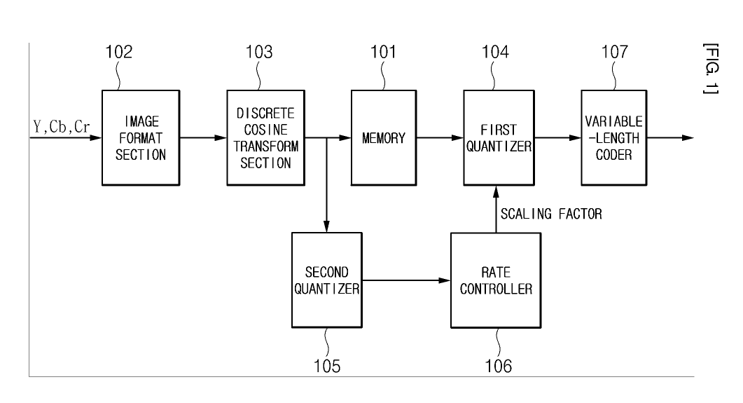

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, preferred embodiments of the present invention will be described in detail with reference to the accompanying drawings.

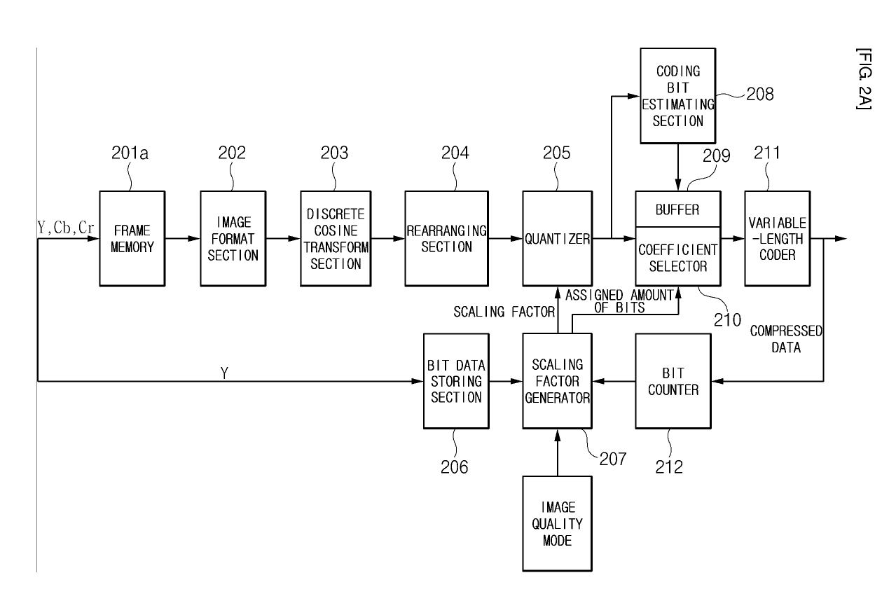

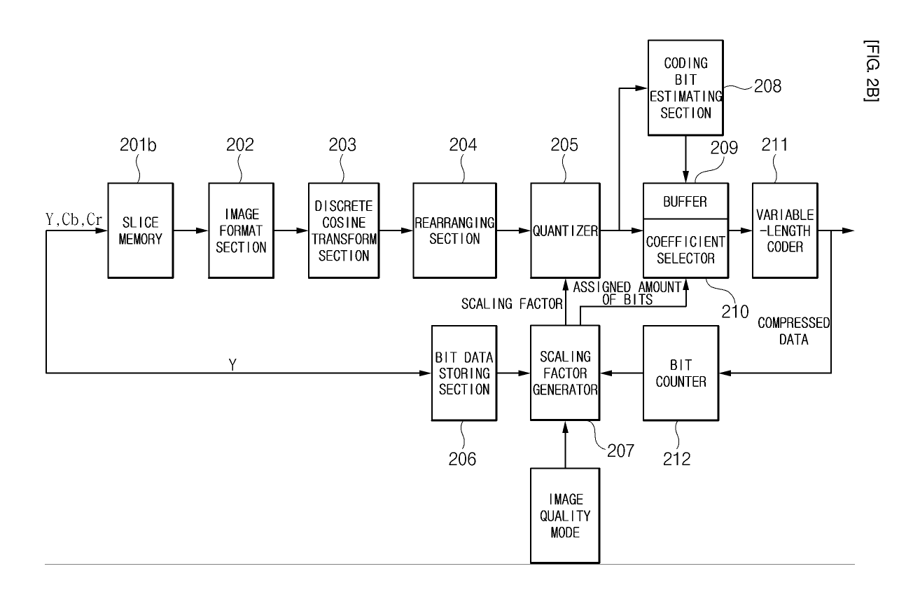

FIGS. 2A and 2B are block diagrams showing an image compression device according to the present invention. The image compression device shown in FIG. 2A includes a frame memory 210a, an image format section 202, a discrete cosine transform section 203, a rearranging section 204, a bit data storing section 206, a scaling factor generator 207, a quantizer 205, a coding bit estimating section 208, a buffer 209, a coefficient selector 210, a variable length coder 211, and a bit counter 212. The image compression device shown in FIG. 2B is almost similar to the image compression device shown in FIG. 2A, except that a slice memory 201b is used instead of the frame memory of FIG. 2A.

The image compression device of FIG. 2A has an advantage in that more precise rate control can be performed by using the frame memory 201a with a large capacity. The image compression device of FIG. 2B has an advantage in that rate control can be performed only by the slice memory 201b with a small capacity.

The frame memory 201a of FIG. 2A and the slice memory 201b of FIG. 2B receive image signal data composed of Y, Cb, Cr signal data. In the frame memory 201a of FIG. 2A, the input image signal data Y, Cb, and Cr are stored in each frame. In the slice memory 201b of the FIG. 2B, the input image signal data Y, Cb, and Cr are stored in each slice of 16×N rows (N is a positive integer).

In the frame memory 201a and the slice memory 201b, the Y, Cb, Cr signal data are formatted in a ratio of 4:2:2, 4:2:0, or 4:1:1 so as to be stored.

The image format section 202 of FIG. 2A, having the frame memory 201a built-in, distinguishes the input image signal data Y, Cb, and Cr for each frame and blocks the distinguished data into a plurality of blocks having a predetermined size to output. The image format section 202 of FIG. 2B, having the slice memory 201b built-in, distinguishes the input image signal data Y, Cb, and Cr for each slice and blocks the distinguished data into a plurality of blocks having a predetermined size to output.

The image format section 202 of FIGS. 2A and 2B outputs CIR656/601 pixel signal data, in which the ratio of Y:Cb:Cr is 4:2:2, 4:2:0, or 4:1, and one frame of vertical and horizontal signals so as to operate as an input suitable for compressing image data Y, Cb, and Cr.

For this, the image format section 202 of FIGS. 2A and 2B first performs color coordinate conversion. In this case, RGB is converted into a YCbCr or YUV format. For example, a formula of CCIR-601 YCbCr color space conversion is as follows:
Y=(77R+150G+29B)/256 Range: 16˜235
Cb=(−44R−87G+131B)/256+128 Range: 16˜240
Cr=(131R−110G−21B)/256+128 Range: 16˜240

The image format section 202 of FIGS. 2A and 2B performs a chroma format conversion on the YCbCr format converted in such a manner, so that the YCbCr of 4:4:4 is converted into 4:2:2, 4:2:0, or 4:1:1.

The chroma format conversion of the image format section 202 of FIGS. 2A and 2B is based on low space sensitivity of eyes with respect to color. The image signal can be represented by four luminance components and two chromaticity components or four luminance components and one chromaticity component (4:4:4->4:2:2, 4:4:4->4:2:0, and 4:4:4->4:1:1).

The image format section 202 of FIGS. 2A and 2B, having the frame memory or slice memory built-in, addresses Y/Cb/Cr pixel data input in the horizontal direction so as to two-dimensionally transmit an 8×8 block of data. In this case, with several 8×8 blocks being set to one unit, the image format section 202 binds YCbCr pixel data to transmit.

The image format section 202 of FIGS. 2A and 2B blocks the input image signal so as to correspond to a unit region (block) composed of a constant number of pixels and outputs the blocked image signal. Generally, the image format section 202 binds four Y blocks, two Cb blocks, and two Cr blocks with 8×8 pixels or four Y blocks, one Cb block, and one Cr block with 8×8 pixels so as to output an image signal.

Meanwhile, the discrete cosine transform section 203 performs the discrete cosine transform on each block input from the image format section 202 so as to output a discrete cosine transform coefficient corresponding to a frequency component.

The discrete cosine transform (DCT) used here converts pixel values, irregularly spread on a screen, into a frequency so as to divide into various frequency components from a low frequency component to a high frequency component and focuses image energy into a low frequency component.

The discrete cosine transform, which is considered as a core technique in various international standards such as H.261, JPEG, MPEG and the like, is carried out in a block unit of 8×8 pixels. The discrete cosine transform is a core element of H.261, JPEG, and MPEG which are multimedia-related international standards.

In the discrete cosine transform, data having high spatial correlation are divided into various frequency components from low frequency components to high frequency components through orthogonal transform, and the respective components are differently quantized.

Here, the block energy is transferred so that most of energy can be focused into the low frequency component of the frequency region so as to increase a compression effect. FIGS. 4A and 4B are diagrams showing an 8×8 block of discrete cosine transform coefficient array. In the drawings, DC and ac1 to ac8 (401) represent low frequency components, and ac55 to ac63 (402) represent high frequency components.

For each block input from the discrete cosine transform section 203, the rearranging section 204 rearranges discrete cosine transform coefficients from low frequency components to high frequency components by using zigzag scan, and then outputs them.

The bit data storing section 206 measures a ratio of the integrated value of edge components of a macro block to the integrated value of overall edge components of a frame by extracting edge components of the Y signal data from the input image signal data Y, Cb, and Cr, and stores bit data calculated from the ratio. In this case, the macro block is a basic unit for encoding an image signal and is composed of four Y signal blocks with 8×8 pixels.

In the case of a 16×16 macro block, if an amount of information of the macro block is referred to as MBIk and an amount of overall information of the frame is referred to as PI, MBIk and PI can be calculated by means of the following Expressions 1 and 2.

$$MBIk = {\sum }_{n = j}^{n = j + 15} {\sum }_{m = i}^{m = i + 14} ( {P}_{( m + 1 , n )} - {P}_{( m , n )} ) \qquad [ Expression 1 ]$$

i=0, 16, 32, . . . , M-16, j=0, 16, 32, . . . , N-16 (M and N means the width and length of a screen)

k=0, 1, 2, . . . , (M/16×N/16)−1

$$PI = {\sum }_{k = 0}^{( M / 16 \times N / 16 ) - 1} MBIk \qquad [ Expression 2 ]$$

k=0, 1, 2, . . . , (M/16×N/16)−1

By means of Expression 3 using Expressions 1 and 2, it is possible to calculate bit data per macro block.
bit data per macro block=MBIk/PI×amount of target bits of frame [Expression 3]

Therefore, if MBIk is 1,000 bits, PI is 10,000 bits, and the amount of target bits of a frame is 100,000 bits, the bit data per macro block becomes 10,000 bits. The amount of target bits of a frame is previously determined by an image quality mode selected by a user.

The scaling factor generator 207 receives the image quality mode selected by a user, the bit data stored in the bit data storing section 206, and the amount of bits calculated by the bit counter 212, which will be described below, so as to assign the amount of bits to the macro block, and then fixes a scaling factor.

The scaling factor generator 207 receives the image quality mode data from a CPU or the like so as to assign an amount of bits per macro block by using the bit data per macro block calculated by the bit data storing section 206 through Expression 3.

If there is an amount of bits accumulated in the previous macro block while being coded through the above construction, the scaling factor generator 207 receives the amount of bits from the bit counter, assigns an amount of bits per macro block by referring to the image mode data, the bit data per macro block, and the amount of bits, and then determines a scaling factor.

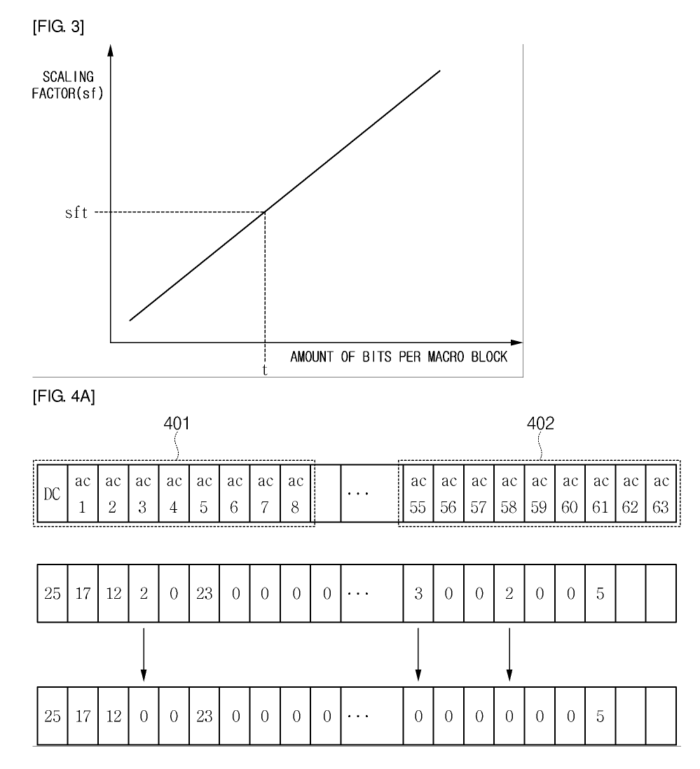

FIG. 3 is a graph showing a scaling factor in accordance with an amount of bits per macro block. As shown in FIG. 3, a scaling factor sf is determined to be sft, when the amount of bits assigned in the macro block by means of Expression 3 is t. It can be found that, if a scaling factor is small, an amount of bits per macro block is small, and if a scaling factor is large, an amount of bits per macro block is large.

Typically, since a high-quality image has a low compression rate, a scaling factor is high, and the total amount of bits at the time of compressing a frame is large. Further, since a low-quality image has a high compression rate, a scaling factor is low, and the total amount of bits at the time of compressing a frame is small.

The quantizer 205 serves to quantize the discrete cosine transform coefficient for each block, input from the rearranging section 205, in accordance with the scaling factor fixed by the scaling factor generator 207.

At this time, a quantization parameter is varied for each block and for each discrete cosine transform coefficient. The quantization parameter serves as a parameter indicating the magnitude of a quantization stage, and the quantization stage is nearly proportional to the quantization parameter. That is, when a quantization parameter is large, a quantization stage becomes so rough that the absolute value of a quantized component becomes small. Therefore, the zero-run length (where components having a value of 0 consecutively arranged) of the quantized component becomes so long that the absolute level value becomes small.

On the contrary, when a quantization parameter is small, a quantization stage becomes so fine that the absolute value of a quantized component becomes large. Therefore, the zero-run length becomes so short that the absolute level value becomes large.

In general, high-frequency components display fine portions of an image, and the damage of some high frequency components does not have an influence on the entire image quality such that it cannot be recognized by the naked eye. Therefore, low frequency components having a large amount of information are finely encoded with the magnitude of quantization being set to be small, and high frequency components are quantized into large values. Then, the compression efficiency is maximized without a large loss.

The data quantized in such a manner includes a large number of data changed into 0, and is input to the variable length coder 211 so as to be changed into a compressed code. For example, quantized discrete cosine transform coefficients shown in FIG. 4A are represented by 25, 17, 12, 2, 0, 23, 0, 0, 0, 0, . . . , 3, 0, 0, 2, 0, 0, 5. It can be found that a large number of data changed into 0 are included.

However, the data quantized in such a manner is an average data obtained by coding a large number of frames, when being actually coded. Therefore, the data for a specific frame is significantly deviated from the amount of target bits per frame. Accordingly, the amount of bits is adjusted once again by additionally constructing the coding bit estimating section 208, the coefficient selector 210, and the bit counter 212. Then, the amount of bits can approach the amount of target bits.

Here, the coding bit estimating section 208 estimates an amount of bits when the discrete cosine transform coefficients quantized by the quantizer 205 is input so as to code the discrete cosine transform coefficients, and then outputs the estimated amount of bits to the coefficient selector 210.

The buffer 209 stores the discrete cosine transform coefficients quantized by the quantizer 205, while the coding bit estimating section 208 estimates an amount of bits when the discrete cosine transform coefficients are coded.

The coefficient selector 210 compares the respective absolute values of the discrete cosine transform coefficients stored in the buffer 209, and compares the amount of bits assigned by the scaling factor generator and the amount of bits estimated by the coding bit estimating section. When the amount of bits assigned by the scaling factor generator 207 is smaller than the amount of bits estimated by the coding bit estimating section 208, the coefficient selector 210 converts the plurality of discrete cosine transform coefficients, of which the absolute values are small, into 0.

The coefficient selector 210 compares the respective absolute values of the discrete cosine transform coefficients input from the quantizer 205. Accordingly, the coefficient selector 210 includes information on the coefficients of which the absolute values are large and the coefficients of which the absolute values are small.

FIGS. 4A and 4B are diagrams showing an 8×8 block of discrete cosine transform coefficients. When it is determined that the amount of bits assigned by the scaling factor generator 207 is smaller than the amount of bits estimated by the coding bit estimating section 208, the coefficients of which the absolute values are small are converted into 0, as shown in FIG. 4A. Accordingly, the number of coded coefficients decreases, so that a code length per macro block is shortened.

In other words, if 2 of ac3, 3 of ac55, and 2 of ac58 are converted into 0 in FIG. 4A, three coefficients do not need to be coded so that a code length per macro block is shortened.

As shown in FIG. 4B, the discrete cosine transform coefficients to ac5 can be coded without being converted into 0, even though the absolute values thereof are small. In image data of a frequency region, a low frequency component 401 is more important than a high frequency component 402. Therefore, as the number of coded discrete cosine transform coefficients having low frequency components becomes large, it is possible to obtain an image with a better quality.

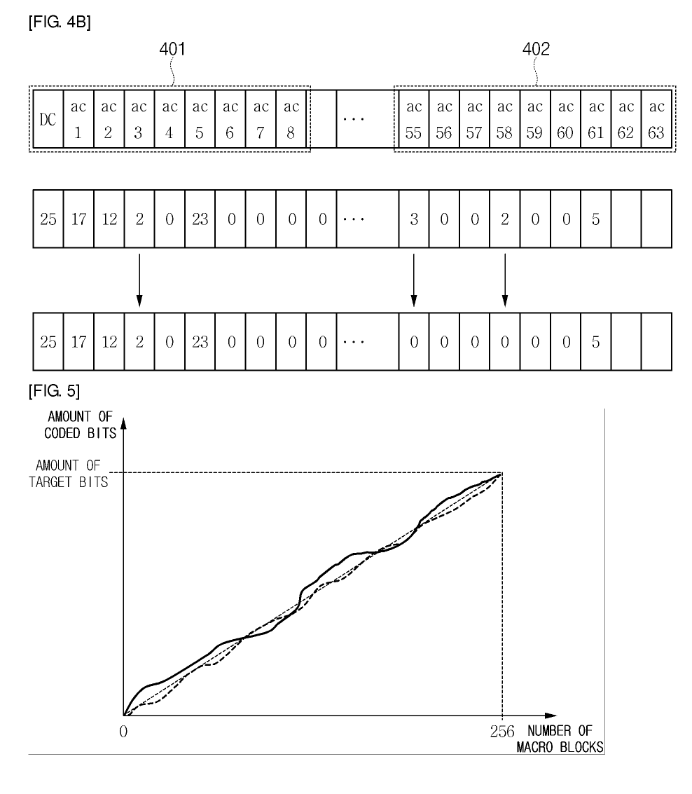

FIG. 5 is a graph showing an amount of target bits in accordance with the number of macro blocks. In FIG. 5, a thin dotted-line indicates an amount of target bits, a thick solid line indicates an amount of bits before the present invention is applied, and a thick dotted-line indicates an amount of bits after the present invention is applied.

In most of compression methods such as JPEG and MPEG, if discrete cosine transform coefficients are converted into 0 as in FIGS. 4A and 4B, an amount of bits to be coded is reduced. Therefore, as shown in FIG. 5, it can be found that an amount of bits approaches the amount of target bits when the present invention is applied. Accordingly, it is possible to perform more accurate rate control.

The variable length coder 211 serves to variable-length code the discrete cosine transform coefficients stored in the buffer 209.

The variable length coder 211 converts a quantized component into an encoded stream for each block by using a code chart showing the correspondence between the value indicating the magnitude of the quantized component and a code.

The bit counter 212 calculates an amount of bits, remaining after variable-length coding, in the amount of bits assigned by the scaling factor generator 207, and then outputs the calculated amount of bits to the scaling factor generator 207.

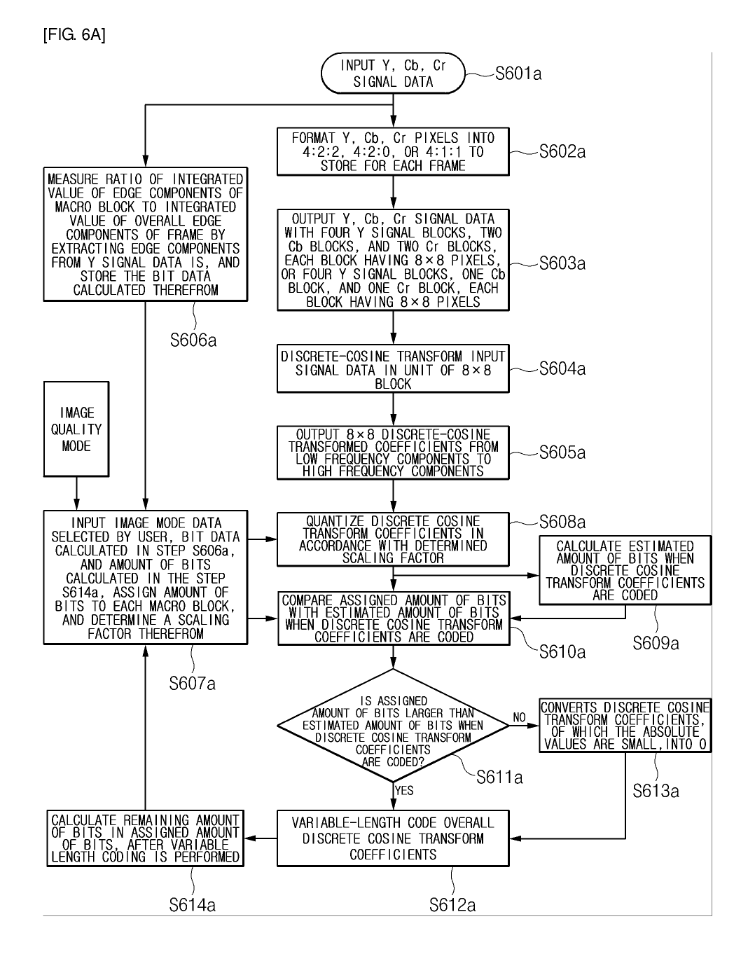

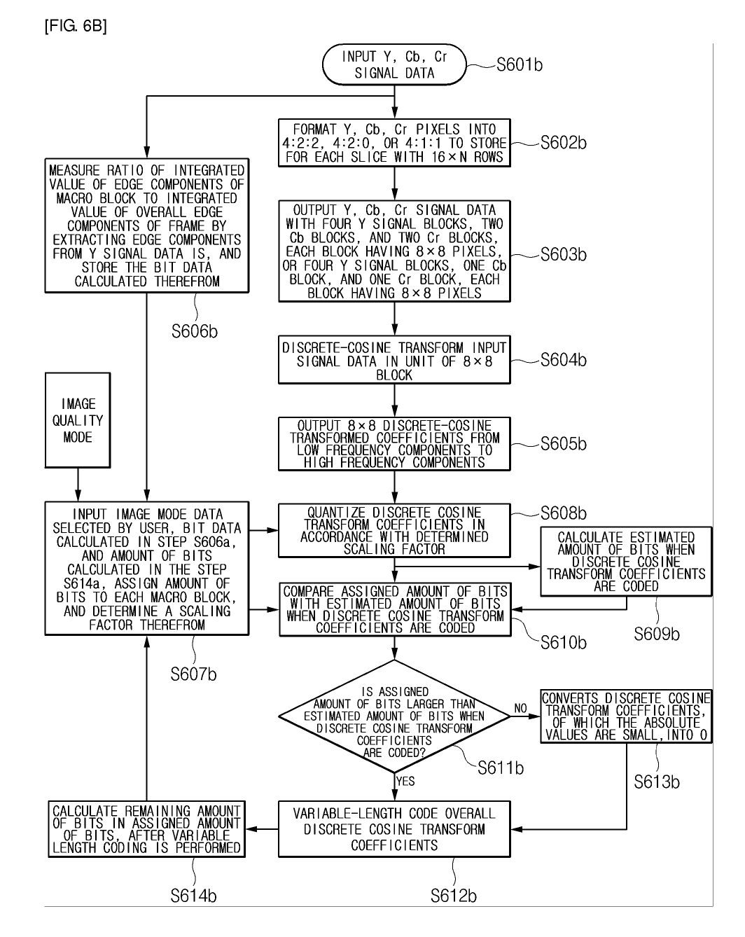

FIGS. 6A and 6B are flow charts showing the image compression method, FIG. 6A showing the image compression method using a frame memory and FIG. 6B showing the image compression method using a slice memory.

As shown in FIG. 6A, the image compression method using the frame memory can be roughly divided in 14 steps.

First, Y, Cb, Cr signal data is input (S601a).

Next, Y, Cb, Cr pixels are formatted in the ratio of 4:2:2, 4:2:0, or 4:1:1 and is stored for each frame (S602a).

Next, the Y, Cb, Cr signal data is output, with a basic unit thereof being composed of four Y signal blocks, two Cb blocks, and two Cr blocks, each block having 8×8 pixels, or four Y signal blocks, one Cb block, and one Cr block, each block having 8×8 pixels (S603a).

Next, the input signal data is discrete-cosine transformed in a unit of 8×8 block (S604a).

Next, 8×8 coefficients which are discrete-cosine transformed are output from low frequency components to high frequency components (605a).

Next, a ratio of the integrated value of edge components of a macro block to the integrated value of overall edge components of a frame by extracting edge components from the Y signal data is measured, and the bit data calculated therefrom is stored (S606a).

Next, image mode data selected by a user, the bit data calculated in the step S606a, and an amount of bits calculated in the step S614a are input so that an amount of bits is assigned to each macro block, and a scaling factor is determined therefrom (S607a).

Next, the discrete cosine transform coefficients are quantized in accordance with the determined scaling factor (S608a).

Next, an estimated amount of bits when the discrete cosine transform coefficients are coded is calculated (S609a).

Next, the assigned amount of bits is compared with the estimated amount of bits when the discrete cosine transform coefficients are coded (S610a).

Next, if the assigned amount of bits is smaller than the estimated amount of bits when the discrete cosine transform coefficients are coded (S611a), the discrete cosine transform coefficients of which the absolute values are small are converted into 0 (S613a), and the overall discrete cosine transform coefficients are variable-length coded (S612a). Otherwise, the overall discrete cosine transform coefficients are immediately variable-length coded (S612a).

Finally, after the variable length coding is performed, a remaining amount of bits in the assigned amount of bits is calculated (S614a). At this time, the calculated amount of bits is input as data for assigning an amount of bits and determining a scaling factor therefrom in the step S607a.

As shown in FIG. 6b, the image compression method using a slice memory can be roughly divided into 14 steps.

First, Y, Cb, Cr signal data is input (S601b).

Next, Y, Cb, Cr pixels are formatted in the ratio of 4:2:2, 4:2:0, or 4:1:1 and is stored for each slice (S602b).

Next, the Y, Cb, Cr signal data is output, with a basic unit thereof being composed of four Y signal blocks, two Cb blocks, and two Cr blocks with 8×8 pixels or four Y signal blocks, one Cb block, and one Cr block with 8×8 pixels (S603b).

Next, the input signal data is discrete-cosine transformed in a unit of 8×8 block (S604b).

Next, 8×8 coefficients which are discrete-cosine transformed are output from low frequency components to high frequency components (605b).

Next, a ratio of the integrated value of edge components of a macro block to the integrated value of overall edge components of a frame by extracting edge components from the Y signal data is measured, and the bit data calculated therefrom is stored (S606b).

Next, image mode data selected by a user, the bit data calculated in the step S606b, and an amount of bits calculated in the step S614b are input so that an amount of bits is assigned to each macro block, and a scaling factor is determined therefrom (S607b).

Next, the discrete cosine transform coefficients are quantized in accordance with the determined scaling factor (S608b).

Next, an estimated amount of bits when the discrete cosine transform coefficients are coded is calculated (S609b).

Next, the assigned amount of bits is compared with the estimated amount of bits when the discrete cosine transform coefficients are coded (S610b).

Next, if the assigned amount of bits is smaller than the estimated amount of bits when the discrete cosine transform coefficients are coded (S611b), the discrete cosine transform coefficients of which the absolute values are small are converted into 0 (S613b), and the overall discrete cosine transform coefficients are variable-length coded (S612b). Otherwise, the overall discrete cosine transform coefficients are immediately variable-length coded (S612b).

Finally, after the variable length coding is performed, a remaining amount of bits in the assigned amount of bits is calculated (S614b). At this time, the calculated amount of bits is input as data for assigning an amount of bits and determining a scaling factor therefrom in the step S607b.

According to the above-described image compression device and method of the present invention, an amount of data which is assigned in a predetermined region within a frame can be varied in accordance with image complexity by adding the bit data storing section, and an image is compressed by comparing an assigned amount of data and an estimated amount of bits when the discrete cosine transform coefficients are coded, which makes it possible to perform more accurate rate control.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image compression device comprising:
a memory to which image signal data is input and in which the image signal data is stored;
an image format section, having the memory built-in, that blocks the input image signal data into a plurality of blocks having a predetermined size to output;
a discrete cosine transform section that performs the discrete cosine transform on each of the blocks input from the image format section so as to output discrete cosine transform coefficients;
a rearranging section that rearranges and outputs the discrete cosine transform coefficients from low frequency components to high frequency components for each of the blocks input from the discrete cosine transform section;
a bit data storing section that measures a ratio of the integrated value of edge components of a macro block to the integrated value of overall edge components of a frame by extracting edge components of predetermined signal data in the input video signal data, and stores bit data calculated from the ratio;
a scaling factor generator that receives image quality mode data selected by a user and the bit data stored in the bit data storing section so as to assign an amount of bits to the macro block, and fixes a scaling factor therefrom;
a quantizer that quantizes the discrete cosine transform coefficients for each block, input from the rearranging section, in accordance with the scaling factor fixed by the scaling factor generator;
a coding bit estimating section that receives the discrete cosine transform coefficients quantized by the quantizer so as to estimate an amount of bits when the discrete cosine transform coefficients are coded;
a buffer that stores the discrete cosine transform coefficients quantized by the quantizer;
a coefficient selector that compares the respective absolute values of the discrete cosine transform coefficients stored in the buffer, and compares the amount of bits assigned by the scaling factor generator and the amount of bits estimated by the coding bit estimating section;
a variable length coder that variable-length codes the discrete cosine transform coefficients, stored in the buffer, so as to output; and
a bit counter that calculates a remaining amount of bits in the amount of bits assigned by the scaling factor generator after variable-length coding, and outputs the calculated amount of bits to the scaling factor generator.

2. The image compression device according to claim 1,
wherein the memory is a frame memory in which the input image signal data is stored for each frame, and
the image format section having the frame memory built-in distinguishes the input image signal data for each frame, and blocks the distinguished image signal data into a plurality of blocks having a predetermined size for each frame so as to output the blocked data.

3. The image compression device according to claim 1,
wherein the memory is a slice memory in which the input image signal data is stored for each slice with 16×N (N is an positive integer) rows, and
the image format section having the slice memory built-in distinguishes the input image signal data for each slice, and blocks the distinguished image signal data into a plurality of blocks having a predetermined size for each slice so as to output the blocked data.

4. The image compression device according to claim 1,
wherein the image signal data is composed of Y, Cb, Cr signal data.

5. The image compression device according to claim 4,
wherein the Y, Cb, Cr signal data is formatted in the ratio of 4:2:2 so as to be stored.

6. The image compression device according to claim 4,
wherein the Y, Cb, Cr signal data is formatted in the ratio of 4:2:0 or 4:1:1 so as to be stored.

7. The image compression device according to claim 5,
wherein the plurality of blocks, having a predetermined size, of the image format section are four Y signal blocks, two Cb signal blocks, and two Cr signal blocks, each block having 8×8 pixels.

8. The image compression device according to claim 6,
wherein the plurality of blocks, having a predetermined size, of the image format section are four Y signal blocks, one Cb signal blocks, and one Cr signal blocks, each block having 8×8 pixels.

9. The image compression device according to claim 4,
wherein the predetermined signal data of the bit data storing section is Y signal data.

10. The image compression device according to claim 9,
wherein the macro block in the bit data storing section and the scaling factor generator is composed of four Y signal blocks with 8×8 pixels.

11. The image compression device according to claim 1,
wherein the coefficient selector converts the plurality of discrete cosine transform coefficients, of which the absolute values are small, into 0 when the amount of bits assigned by the scaling factor generator is smaller than the amount of bits estimated by the coding bit estimating section.

12. An image compression method comprising:
receiving and storing image signal data;
blocking the input image signal data into a plurality of blocks with a predetermined size so as to output;
performing the discrete cosine transform on each of the output blocks so as to output discrete cosine transform coefficients;
rearranging the output discrete cosine transform coefficients from low frequency components to high frequency components for each block so as to output;
measuring a ratio of the integrated value of edge components of a macro block to the integrated value of overall edge components of a frame by extracting edge components of predetermined signal data in the input image signal data, and storing bit data calculated from the ratio;
receiving the stored bit data and image quality mode data selected by a user so as to assign an amount of bits to the macro block, and fixing a scaling factor therefrom;
quantizing the output discrete cosine transform coefficients for each block in accordance with the fixed scaling factor;
receiving the quantized discrete cosine transform coefficients, and estimating an amount of bits when the discrete cosine transform coefficients are coded;
storing the quantized discrete cosine transform coefficients, comparing the respective absolute values of the stored discrete cosine transform coefficients, and comparing the assigned amount of bits and the estimated amount of bits;
variable-length coding the stored discrete cosine transform coefficients to output; and
calculating an amount of bits, remaining after variable-length coding, in the assigned amount of bits.

13. The image compression method according to claim 12,
wherein, in the step of receiving and storing image signal data, the input image signal data is stored for each frame, and
in the step of blocking the input video signal data to output, the input image signal data is distinguished for each frame, and is blocked into a plurality of blocks with a predetermined size for each frame so as to be output.

14. The image compression method according to claim 12,
wherein, in the step of receiving and storing image signal data, the input image signal data is stored for each slice with 16×N (N is a positive integer) rows, and
in the step of blocking the input image signal data to output, the input image signal data is distinguished for each slice, and is blocked into a plurality of blocks with a predetermined size for each slice so as to be output.

15. The image compression method according to claim 12,
wherein, in the step of receiving and storing image signal data, image signal data composed of Y, Cb, Cr signal data is input.

16. The image compression method according to claim 15,
wherein, in the step of receiving and storing image signal data, the Y, Cb, Cr signal data is formatted in the ratio of 4:2:2 so as to be stored.

17. The image compression method according to claim 15,
wherein, in the step of receiving and storing image signal data, the Y, Cb, Cr signal data is formatted in the ratio of 4:2:0 or 4:1:1 so as to be stored.

18. The image compression method according to claim 16,
wherein, in the step of blocking the input video signal data to output, four Y signal blocks, two Cb signal blocks, and two Cr signal blocks, each block having 8×8 pixels, are blocked and output.

19. The image compression method according to claim 17,
wherein, in the step of blocking the input video signal data to output, four Y signal blocks, one Cb signal block, and one Cr signal block, each block having 8×8 pixels are blocked and output.

20. The image compression method according to claim 15,
wherein, in the step of measuring a ratio and storing bit data calculated from the ratio, edge components of Y signal data are extracted.

21. The image compression method according to claim 20,
wherein the steps of storing bit data calculated from the ratio and receiving the stored bit data so as to assign an amount of bits are performed with the macro block being set to a basic unit, the macro block composed of four Y signal blocks with 8×8 pixels.

22. The image compression method according to claim 12,
wherein the step of storing the quantized discrete cosine transform coefficients further includes converting the plurality of discrete cosine transform coefficients, of which the absolute values are small, into 0 when the assigned amount of bits is smaller than the estimated amount of bits.

23. The image compression method according to claim 12,
wherein, when a remaining amount of bits is calculated in the step of calculating a remaining amount of bits, the amount of bits is input as data of the step of receiving the stored bit data so as to assign an amount of bits.
